(19) United States
(12) Patent Application Publication
(10) Pub. No.: US 2007/0262951 A1
(43) Pub. Date: Nov. 15, 2007

(54) Proximity sensor device and method with improved indication of adjustment

(75) Inventors: Mark Huie, Sunnyvale, CA (US); Wendy Cheng, Santa Clara, CA (US)

Correspondence Address: INGRASSIA FISHER & LORENZ, P.C. (SYNA), 7150 E. CAMELBACK ROAD, SUITE 325, SCOTTSDALE, AZ, 85251, US

(73) Assignee: Synaptics Incorporated

(21) Appl. No.: 11/431,345

(22) Filed: May 9, 2006

(51) Int. Cl. G09G 5/00

(52) U.S. Cl. 345/156

(57) ABSTRACT

A proximity sensor device and method is provided that facilitates improved system usability. Specifically, the proximity sensor device and method provide the ability for a user to easily cause adjustments in an electronic system using a proximity sensor device as a user interface. For example, it can be used to facilitate user interface navigation, such as scrolling. As another example, it can be used to facilitate value adjustments, such as changing a device parameter. To facilitate adjustment, the embodiments of the present invention provide a proximity sensor device that is adapted to indicate adjustment in a first way responsive to object motion in both of two opposite directions along a path proximate the touch sensor device. This facilitates use of the proximity sensor device by a user to indicate adjustments to an electronic device, and is particularly useful for indicating continuing adjustments.

### FIELD OF THE INVENTION

This invention generally relates to electronic devices, and more specifically relates to proximity sensor devices.

### BACKGROUND OF THE INVENTION

Proximity sensor devices (also commonly called touch pads or touch sensor devices) are widely used in a variety of electronic systems. A proximity sensor device typically includes a sensing region, often demarked by a surface, which uses capacitive, resistive, inductive, optical, acoustic and/or other technology to determine the presence, location and/or motion of one or more fingers, styli, and/or other objects. The proximity sensor device, together with finger(s) and/or other object(s), can be used to provide an input to the electronic system. For example, proximity sensor devices are used as input devices for larger computing systems, such as those found integral within notebook computers or peripheral to desktop computers. Proximity sensor devices are also used in smaller systems, including: handheld systems such as personal digital assistants (PDAs), remote controls, communication systems such as wireless telephones and text messaging systems. Increasingly, proximity sensor devices are used in media systems, such as CD, DVD, MP3, video or other media recorders or players.

Many electronic devices include a user interface, or UI, and an input device for interacting with the UI (e.g., interface navigation). A typical UI includes a screen for displaying graphical and/or textual elements. The increasing use of this type of UI has led to a rising demand for proximity sensor devices as pointing devices. In these applications the proximity sensor device can function as a value adjustment device, cursor control device, selection device, scrolling device, graphics/character/handwriting input device, menu navigation device, gaming input device, button input device, keyboard and/or other input device.

Scrolling-type input allows users to navigate through relatively large sets of data. For example, scrolling allows a user to move through an array of data to select a particular entry. As another example, scrolling allows a user to bring particular sections of a large document into view on a display screen that is too small to view the entire document at once. In a system with a traditional graphical UI, programs for navigating documents will include one or more scrollbars to facilitate scrolling through the document. Scrollbars are relatively effective when used with traditional input devices, such a computer mouse or trackball. However, using them with different input devices, particularly proximity sensor devices, can require a significant level of attention and dexterity.

Various attempts have been made to better facilitate scrolling functions using a proximity sensor device. One technique, for example, uses a touchpad to perform both pointing and “virtual” scrolling functions using regions at the right and/or bottom of the pad dedicated to vertical and horizontal scrolling, respectively. An exemplary implementation of scrolling performed on a proximity sensor device is described in U.S. Pat. No. 5,943,052.

Another technique for scrolling uses a portion of a pen-actuated touchpad roughly as a “jog dial” where pen motion around the center of the dial is used to generate scrolling signals. Typically, the rate of generation of scrolling signals is proportional to the rate of angle subtended by the pen as it moves around the center of the dial. Jog dial scrolling can offer significant usability improvement. However, the idea of a jog dial is conceptually distinct from that of a linear scroll bar and therefore training naïve users in its use is non-trivial.

Thus, while many different techniques have been used to facilitate scrolling, there remains a continuing need for improvements in device usability. Particularly, there is a continuing need for improved techniques for facilitating scrolling with proximity sensor devices.

### BRIEF SUMMARY OF THE INVENTION

The present invention provides a proximity sensor device and method that facilitates improved system usability. Specifically, the proximity sensor device and method provide the ability for a user to easily cause an adjustment in an electronic system using a proximity sensor device as a user interface. For example, it can be used to facilitate user interface navigation, such as scrolling. As another example, it can be used to facilitate value adjustments, such as changing a device parameter. To facilitate adjustment, the embodiments of the present invention provide a proximity sensor device that is adapted to indicate adjustment in a first way responsive to object motion in both of two opposite directions along a path proximate a first sensing region of the touch sensor device. This facilitates use of the proximity sensor device by a user to indicate adjustments to an electronic device. It is particularly useful for indicating continuing adjustments, for example, to facilitate scrolling through a large document. In those cases the continued adjustment can be indicated by object motion back and forth along the path. This allows a user to continue to scroll through a document without requiring the user to perform a more complex gesture on the proximity sensor device, such as repeatedly lifting and retouching a finger to the sensing region.

In another embodiment, the proximity sensor device is implemented with multiple regions. For example, a second sensing region can be provided and adapted to indicate adjustment in a second way responsive to object motion in both of two opposite directions along a path proximate the touch sensor device. This adjustment in a second way facilitates use of the proximity sensor device to indicate adjustments of a different type or in a different manner than indicated by the first region. For example, the first region can be used to indicate scrolling up by moving an object back and forth along a path in the first region, while the second region can be used to indicate scrolling down by moving the object back and forth along a path in the second region. The combination of regions thus allows a user to continue to scroll through a document in either direction without requiring the user to perform a more complex gesture on the proximity sensor device.

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an exemplary system that includes a proximity sensor device in accordance with an embodiment of the invention;

FIGS. 2-6 are schematic views of a proximity sensor device in accordance with embodiments of the invention;

FIGS. 7-8 are schematic views of a proximity sensor device in accordance with embodiments of the invention;

FIGS. 9-10 are schematic views of proximity sensor devices with two sensing regions in accordance with embodiments of the invention;

FIGS. 11-15 are schematic views of proximity sensor devices with three sensing regions in accordance with embodiments of the invention; and

FIGS. 16-17 are schematic views of proximity sensor devices with five sensing regions in accordance with embodiments of the invention.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The present invention provides a proximity sensor device and method that facilitates improved system usability. Specifically, the proximity sensor device and method provide the ability for a user to easily cause adjustments in an electronic system using a proximity sensor device as a user interface. For example, it can be used to facilitate user interface navigation, such as scrolling. As another example, it can be used to facilitate value adjustments, such as changing a device parameter. To facilitate usability, the embodiments of the present invention provide a touch sensor device that is adapted to indicate adjustment in a first way responsive to object motion in both of two opposite directions along a path proximate the touch sensor device. This facilitates use of the proximity sensor device by a user to indicate adjustments to an electronic device by moving an object to generate the object motion. It is particularly useful for indicating continuing adjustments, for example, to facilitate scrolling through a large document. In those cases the continued adjustment can be indicated by moving the object back and forth along the path. This allows a user to continue to scroll through a document without requiring the user to perform a more complex gesture on the proximity sensor device.

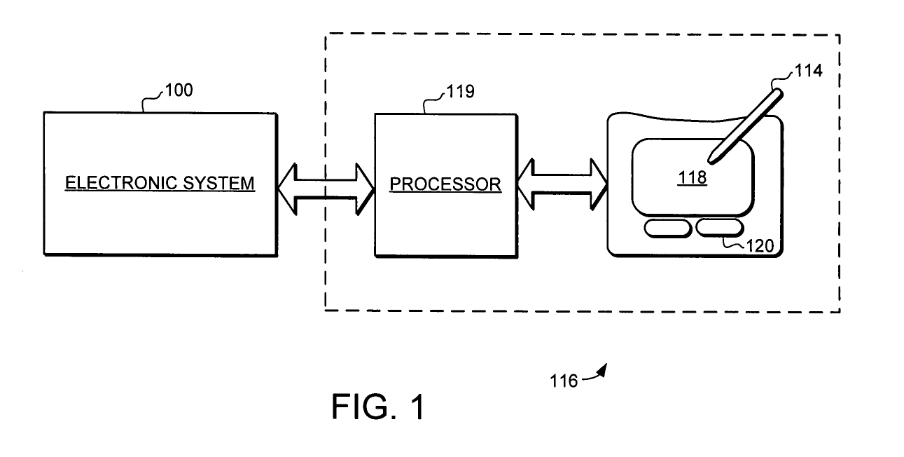

Turning now to the drawing figures, FIG. 1 is a block diagram of an exemplary electronic system 100 that is coupled to a proximity sensor device 116. Electronic system 100 is meant to represent any type of personal computer, portable computer, workstation, personal digital assistant, video game player, communication device (including wireless phones and messaging devices), media device, including recorders and players (including televisions, cable boxes, music players, and video players) or other device capable of accepting input from a user and of processing information. Accordingly, the various embodiments of system 100 may include any type of processor, memory or display. Additionally, the elements of system 100 may communicate via a bus, network or other wired or wireless interconnection. The proximity sensor device 116 can be connected to the system 100 through any type of interface or connection, including I2C, SPI, PS/2, Universal Serial Bus (USB), Bluetooth, RF, IRDA, or any other type of wired or wireless connection to list several non-limiting examples.

Proximity sensor device 116 includes a processor 119 and a sensing region 118. Proximity sensor device 116 is sensitive to the position of a stylus 114, finger and/or other input object within the sensing region 118. “Sensing region” 118 as used herein is intended to broadly encompass any space above, around, in and/or near the proximity sensor device 116 wherein the sensor of the touchpad is able to detect a position of the object. In a conventional embodiment, sensing region 118 extends from the surface of the sensor in one or more directions for a distance into space until signal-to-noise ratios prevent object detection. This distance may be on the order of less than a millimeter, millimeters, centimeters, or more, and may vary significantly with the type of position sensing technology used and the accuracy desired. Accordingly, the planarity, size, shape and exact locations of the particular sensing regions 116 will vary widely from embodiment to embodiment.

In operation, proximity sensor device 116 suitably detects a position of stylus 114, finger or other input object within sensing region 118, and using processor 119, provides electrical or electronic indicia of the position to the electronic system 100. The system 100 appropriately processes the indicia to accept inputs from the user, to move a cursor or other object on a display, or for any other purpose.

The proximity sensor device 116 can use a variety of techniques for detecting the presence of an object. As several non-limiting examples, the proximity sensor device 116 can use capacitive, resistive, inductive, surface acoustic wave, or optical techniques. In a common capacitive implementation of a touch sensor device a voltage is typically applied to create an electric field across a sensing surface. A capacitive proximity sensor device 116 would then detect the position of an object by detecting changes in capacitance caused by the changes in the electric field due to the object. Likewise, in a common resistive implementation a flexible top layer and a bottom layer are separated by insulating elements, and a voltage gradient is created across the layers. Pressing the flexible top layer creates electrical contact between the top layer and bottom layer. The resistive proximity sensor device 116 would then detect the position of the object by detecting the voltage output due to changes in resistance caused by the contact of the object. In an inductive implementation, the sensor might pick up loop currents induced by a resonating coil or pair of coils, and use some combination of the magnitude, phase and/or frequency to determine distance, orientation or position. In all of these cases the proximity sensor device 116 detects the presence of the object and delivers position information to the system 100. Examples of the type of technologies that can be used to implement the various embodiments of the invention can be found at U.S. Pat. No. 5,543,591, U.S. Pat. No. 6,259,234 and U.S. Pat. No. 5,815,091, each assigned to Synaptics Inc.

Proximity sensor device 116 includes a sensor (not shown) that utilizes any combination of sensing technology to implement one or more sensing regions. For example, the sensor of proximity sensor device 116 can use arrays of capacitive sensor electrodes to support any number of sensing regions. As another example, the sensor can use capacitive sensing technology in combination with resistive sensing technology to support the same sensing region or different sensing regions. Depending on sensing technique used for detecting object motion, the size and shape of the sensing region, the desired performance, the expected operating conditions, and the like, proximity sensor device 116 can be implemented with a variety of different ways. The sensing technology can also vary in the type of information provided, such as to provide “one-dimensional” position information (e.g. along a sensing region) as a scalar, “two-dimensional” position information (e.g. horizontal/vertical axes, angular/radial, or any other axes that span the two dimensions) as a combination of values, and the like.

The processor 119, sometimes referred to as a proximity sensor processor or touch sensor controller, is coupled to the sensor and the electronic system 100. In general, the processor 119 receives electrical signals from the sensor, processes the electrical signals, and communicates with the electronic system. The processor 119 can perform a variety of processes on the signals received from the sensor to implement the proximity sensor device 116. For example, the processor 119 can select or connect individual sensor electrodes, detect presence/proximity, calculate position or motion information, and report a position or motion when a threshold is reached, and/or interpret and wait for a valid tap/stroke/character/button/gesture sequence before reporting it to the electronic system 100, or indicating it to the user. The processor 119 can also determine when certain types or combinations of object motions occur proximate the sensor. For example, the processor 119 can determine when object motion crosses from one region on the sensor to another region, and can generate the appropriate indication in response to that motion.

In this specification, the term “processor” is defined to include one or more processing elements that are adapted to perform the recited operations. Thus, the processor 119 can comprise all or part of one or more integrated circuits, firmware code, and/or software code that receive electrical signals from the sensor and communicate with the electronic system 100. In some embodiments, the elements that comprise the processor 119 would be located with or near the sensor. In other embodiments, some elements of the processor 119 would be with the sensor and other elements of the processor 119 would reside on or near the electronic system 100. In this embodiment minimal processing could be performed near the sensor, with the majority of the processing performed on the electronic system 100.

Furthermore, the processor 119 can be physically separate from the part of the electronic system that it communicates with, or the processor 119 can be implemented integrally with that part of the electronic system. For example, the processor 119 can reside at least partially on a processor performing other functions for the electronic system aside from implementing the proximity sensor device 116.

Again, as the term is used in this application, the term “electronic system” broadly refers to any type of device that communicates with proximity sensor device 116. The electronic system 100 could thus comprise any type of device or devices in which a touch sensor device can be implemented in or coupled to. The proximity sensor device could be implemented as part of the electronic system 100, or coupled to the electronic system using any suitable technique. As non-limiting examples the electronic system 100 could thus comprise any type of computing device, media player, communication device, or another input device (such as another touch sensor device or keypad). In some cases the electronic system 100 is itself a peripheral to a larger system. For example, the electronic system 100 could be a data input or output device, such as a remote control or display device, that communicates with a computer or media system (e.g., remote control for television) using a suitable wired or wireless technique. It should also be noted that the various elements (processor, memory, etc.) of the electronic system 100 could be implemented as part of an overall system, as part of the touch sensor device, or as a combination thereof. Additionally, the electronic system 100 could be a host or a slave to the proximity sensor device 116.

In the illustrated embodiment the proximity sensor device 116 is implemented with buttons 120. The buttons 120 can be implemented to provide additional input functionality to the proximity sensor device 116. For example, the buttons 120 can be used to facilitate selection of items using the proximity sensor device 116. Of course, this is just one example of how additional input functionality can be added to the proximity sensor device 116, and in other implementations the proximity sensor device 116 could include alternate or additional input devices, such as physical or virtual switches, or additional proximity sensing regions. Conversely, the proximity sensor device 116 can be implemented with no additional input devices.

It should be noted that although the various embodiments described herein are referred to as “proximity sensor devices”, “touch sensor devices”, “proximity sensors”, or “touch pads”, these terms as used herein are intended to encompass not only conventional proximity sensor devices, but also a broad range of equivalent devices that are capable of detecting the position of a one or more fingers, pointers, styli and/or other objects. Such devices may include, without limitation, touch screens, touch pads, touch tablets, biometric authentication devices, handwriting or character recognition devices, and the like. Similarly, the terms “position” or “object position” as used herein are intended to broadly encompass absolute and relative positional information, and also other types of spatial-domain information such as velocity, acceleration, and the like, including measurement of motion in one or more directions. Various forms of positional information may also include time history components, as in the case of gesture recognition and the like. Accordingly, proximity sensor devices can appropriately detect more than the mere presence or absence of an object and may encompass a broad range of equivalents.

In the embodiments of the present invention, the proximity sensor device 116 is adapted to provide the ability for a user to easily cause adjustments in an electronic system using a proximity sensor device 116 as part of a user interface. For example, it can be used to facilitate user interface navigation, such as scrolling, panning, menu navigation, cursor control, and the like. As another example, it can be used to facilitate value adjustments, such as changing a device parameter, including visual parameters such as color, hue, brightness, and contrast, auditory parameters such as volume, pitch, and intensity, operation parameters such as speed and amplification. The proximity sensor device 116 can also be used for control of mechanical devices, such as in controlling the movement of a machine. To facilitate adjustment, the embodiments of the present invention provide a proximity sensor device that is adapted to indicate adjustment in a first way responsive to object motion in both of two opposite directions along a path proximate the proximity sensor device 116. This facilitates use of the proximity sensor device 116 by a user to cause indication of adjustments to an electronic device. It is particularly useful for indicating continuing adjustments, for example, to facilitate scrolling through a large document. In those cases the continued adjustment can be indicated by the user moving the object back and forth along the path proximate the sensing region 118. This allows a user to continue to scroll through a document without requiring the user to perform a more complex gesture on the proximity sensor device.

It should also be understood that while the embodiments of the invention are described herein the context of a fully functioning proximity sensor device, the mechanisms of the present invention are capable of being distributed as a program product in a variety of forms. For example, the mechanisms of the present invention can be implemented and distributed as a proximity sensor program on a computer-readable signal bearing media. Additionally, the embodiments of the present invention apply equally regardless of the particular type of signal bearing media used to carry out the distribution. Examples of signal bearing media include: recordable media such as memory cards, optical and magnetic disks, hard drives, and transmission media such as digital and analog communication links.

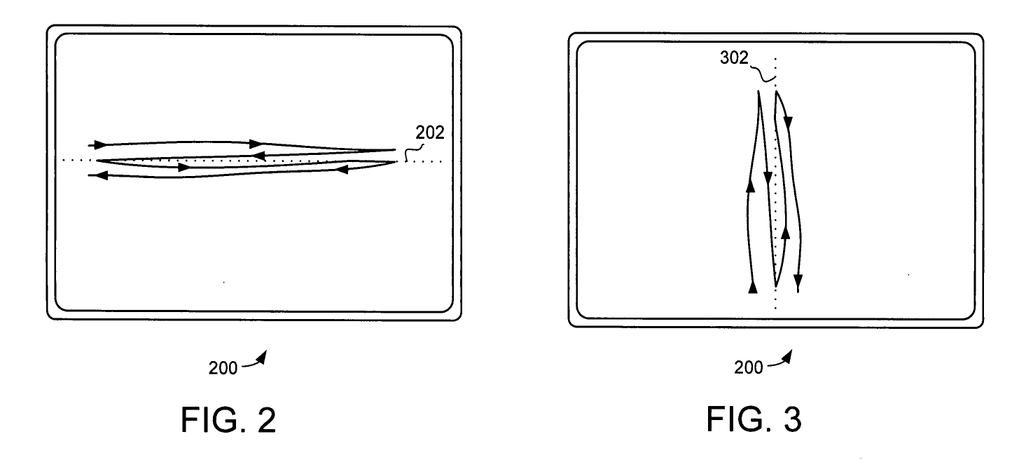

Turning now to FIG. 2, an exemplary proximity sensor device 200 is illustrated. The proximity sensor device 200 illustrates how a device can be implemented to receive user interface input and generate adjustments such as scrolling responsive to relatively simple, easy to perform gestures. FIG. 2 illustrates an exemplary path 202 that a user may follow on the proximity sensor device 200, indicated by a dotted line, and shows how a user can create object motion in two opposite directions along the path 202.

In accordance with the embodiments of the invention, the touch sensor device facilitates user input of adjustment responsive to object motion in the two opposite directions along the path 202, and indicates adjustment in a same way responsive to motion in both of the opposite directions along the path 202. Thus, the user of proximity sensor device 200 can cause adjustment in the first way by moving an object back and forth along the path 202. This allows a user to input relatively large adjustments with relatively simple, easy to perform gestures. It should be noted that “two opposite directions along a path” can comprise merely substantially following the path in one direction, and substantially following the path in the other direction. Thus, to continue adjustment it is not required that the object motion precisely follow any particular path in both directions.

It also should be emphasized that object motion along the path in both directions causes the proximity sensor device to indicate adjustment in the same way, e.g., in the same direction. For example, the proximity sensor device 200 can be implemented such that moving back and moving forth along the path both generates downward scrolling. In this embodiment, motion in a first direction along the path 202 generates downward scrolling, and motion in the opposite direction along the path 202 also generates downward scrolling. Facilitating adjustment in the same way (e.g., scrolling in the same direction) responsive to object motion in both of two opposite directions facilitates inputting large adjustments with relatively simple, easy to learn and easy to perform gestures. Specifically, it is relatively easy for a user to continue to scroll down by simply moving the object back and forth along the path. Thus, the proximity sensor device 200 can facilitate the entry of extended continuous adjustments, such as long scrolling, with relatively simple and easy to perform gestures.

It should be noted that the “path” referred to an illustrated is merely the path along which the object motion follows. Thus, path 202 is merely exemplary of numerous potential paths on the proximity sensor device 200 that be utilized to generate adjustment in the first way. For example, a user can input adjustment by moving the object up and down a along vertical path, moving the object diagonally along a diagonal path, moving the object around a non-linear path, etc.

Additionally, the path taken by the object can be in any direction detectable by the sensor. Turning briefly to FIG. 3, FIG. 3 illustrates a vertical path 302 which can be used for adjustment using the same techniques. In this example, object motion along the vertical path in both directions again generates adjustment in the same way.

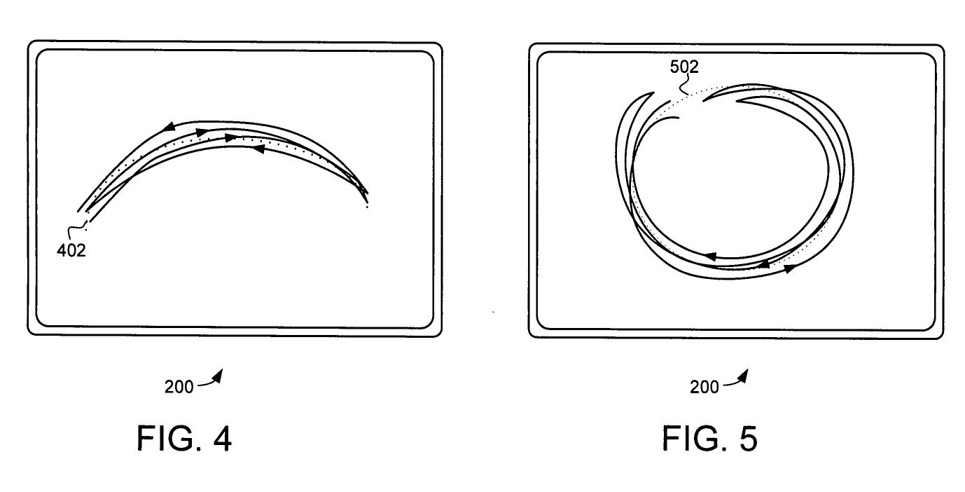

Additionally, the path taken by the object can have any shape. Turning briefly to FIG. 4, FIG. 4 illustrates a curved path 402 which can be used for adjustment using the same techniques. In this example, object motion along the curved path in both directions again generates adjustment in the same way. Turning briefly to FIG. 5, FIG. 5 illustrates a substantially circularly path 502 which can be used for adjustment using the same techniques. In this example, object motion along the circular path in both directions again generates adjustment in the same way. Stated another way, the path can be any path proximate the sensor along which the user moves an object.

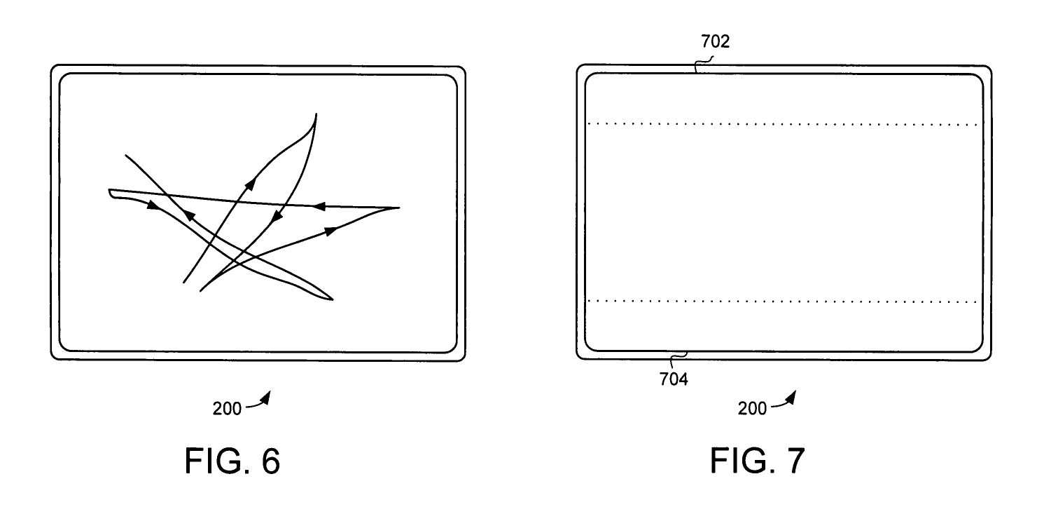

It should be noted that various paths illustrated are shown for convenience of discussion, and that a user does not need to follow any particular path in both directions to indicate the adjustment in the same way using such a system. For example, the user can trace the path partially and in only one direction, if that indicates sufficient adjustment. The system can also be implemented to accept a path that closes on itself, such as by a circle, polygon, or figure eight, where infinite movement in one direction along the path is possible. The system can also be implemented to accept only the component of paths along an axis, such as a straight line in a roughly linear sensing region or a circle or other closed-loop path in a roughly circular or annular sensing region; this approach is especially applicable for a “one-dimensional” sensing region. Alternatively, the proximity sensor device 200 can be implemented such that the user can choose to follow a first path in both directions for some time, and then deviate from that first path to a second path. Regardless of the path the user chooses, the proximity sensor device 200 functions by indicating adjustment in the same way even if the user chooses to traverse the path in a forward and in a reverse direction. Turning briefly to FIG. 6, FIG. 6 illustrates how a user can move over different paths while still causing adjustment in the same way. Thus, while the proximity sensor device 200 is implemented to generate adjustment in the same way responsive to object motion in two directions along the path, the user can cause adjustment using any combination of motions along the surface on the proximity sensor device.

Finally, it should be noted that because the shape of the paths is usually determined merely by the object motion, there is no requirement for any specific indication of the path on the proximity sensor device 202, or any particular structure on the proximity sensor device 202 corresponding to the path. Furthermore the path need not share any sort of shape relationship with the shape of the sensing area on the proximity sensor device. Thus, adjustment can be generated using motion along a curved path in a rectangular-shaped sensing region. Likewise, adjustment can be caused using motion along a straight path in a circular shaped sensing region.

Likewise, the proximity sensor device can also be further configured to indicate adjustment in the same way responsive to object motion proximate the proximity sensor device in any direction (i.e. regardless of the direction of the object motion). In this case, the user can move the object in any direction proximate the proximity sensor device and cause adjustment in the same way.

The proximity sensor device 200 can be used to facilitate a wide variety of different inputs to an electronic system by a user. In this specification the type of inputs to the electronic system generated are generally referred to as “adjustments”. One example of an adjustment that can be performed with the proximity sensor device 200 is user interface navigation. User interface navigation can comprise a variety interface activities, such as horizontal and vertical scrolling, dragging, selecting among menu options, stepping through a list, etc. In all these cases the user interface navigation occurs in the same way responsive to object motion in both of the two opposite directions along a path. For example, moving back and forth along the path can cause scrolling down. In other embodiments moving back and forth along the path can cause panning to the left, or zooming in, etc. One specific type of user interface navigation is scrolling. In general, scrolling is defined as causing a display window to move its viewing region within a larger space of data. For example, to move within a large document to display a different portion of the document. Scrolling also can include moving a selection point within a list, menu, or other set of data.

It should also be noted that scrolling and other actions can be combined with selection. For example, the proximity sensor device can be implemented to cause scrolling in a first way responsive to object motion in both of two opposite directions along a path proximate the sensor, and then to cause selection when the object motion proximate the sensor ceases (e.g., when the object stops moving or when the object is lifted from the sensor). Thus, as one specific example, a user can easily scroll through a large list of elements with object motion in opposite directions along a path, and then the user can select the desired element by lifting the object, a relatively easy to perform combination of gestures.

Another example of a type of adjustment is a value adjustment. In a value adjustment the proximity sensor device is used to change a value on the system. For example, by increasing or decreasing the quantity of a selected field on the device. As one specific example, by moving the object back and forth along a path a user can cause a selected field value to continue to increase until a desired quantity is reached. Alternatively, the value adjustment may relate to a functional parameter, such as increasing volume or contrast or aiming a camera to the right.

In some cases it will be desirable to facilitate user changing of the adjustment. For example, it may be desirable to allow a user to change the manner (or way) of adjustment, such as to change between scrolling up and down, or to change between panning left or right. It may also be desirable to allow the user to change a factor associated with the manner or way of adjustment, such the speed of adjustment. In other cases it will be desirable to facilitate user selection of the type of adjustment. In this embodiment the user can select what is being adjusted. For example, the user can select from various user interface navigation activities, such as from scrolling to panning, etc.

The proximity sensor device 200 can be implemented to cause changing of adjustment and user selection of what is being adjusted responsive to a variety of different actions by the user. For example, it can be implemented such that a user can cause a change in adjustment using other keys, buttons, or input devices on the device. Additionally, the proximity sensor device 200 can be implemented to recognize special gestures proximate to proximity sensor device 200 to select and change the adjustments. In all these cases the proximity sensor device 200 can be implemented to allow a user to change the way or type of adjustment as needed.

As one specific example, the proximity sensor device 200 can be implemented to select the adjustment based on the location of an initial object motion proximate the sensing region. Turning now to FIG. 7, the proximity sensor device 200 is illustrated with two regions used to select the adjustment. In this embodiment the top region 702 (i.e., the region above the top dotted line) is used to select one adjustment, and the bottom region 704 (i.e., the region below the bottom dotted line) is used to select another adjustment. For example, the top region 702 can be used to select scrolling up, and the bottom region 704 used to select scrolling down. Alternatively, the top region 702 can be used select panning, and the bottom region 704 used to select zooming. In any case the user can select the first adjustment by initially placing the object in the top region 702 and continuing object motion from there. It should be noted that in this embodiment once the initial placement of the object occurs and selects the adjustment there is no requirement that object motion be limited to within the particular region. Instead, in most embodiments it will be desirable to facilitate continuation of the selected adjustment responsive to object motion all over the proximity sensor device 200 until terminated by an event. In other embodiments, the object motion is limited to within the region of initial placement if the adjustment in the same way is desired. Many termination events are possible. For example, until it is terminated by object motion stopping and holding substantially still for a relatively long time period, by the object leaving from the proximity sensor device 200, by the object performing a specific gesture such as a tap or a question mark, by a signal from something external to the proximity sensor device 200, within the electronic system in communication with the proximity sensor device 200 (e.g. from an application running on the electronic system), or external to the electronic system.

It should also be noted that this is just one example of how the regions can be defined, and in other embodiments it may be desirable to include additional regions to facilitate additional adjustment selections. For example, these regions could be defined by the processor dynamically. In these embodiments, the sensing region size or shape may also be changed dynamically in response to user input, operating conditions, system functions, applications active, history of input and the like. For example, the indicating adjustment functionality can be turned on and off, enabling other modes where other functionality (e.g. selection, cursor control) is supported by the sensing region.

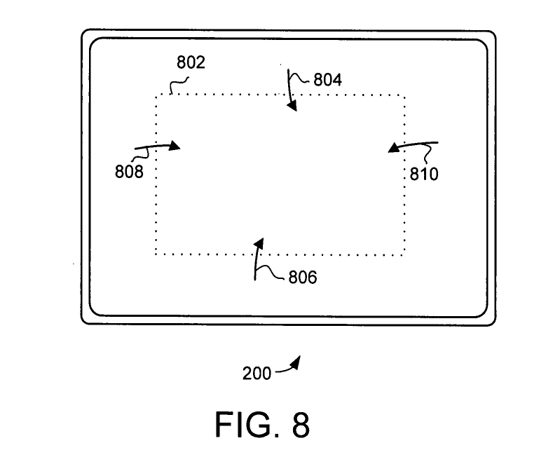

As another specific example embodiment, the proximity sensor device 200 can be implemented to select the adjustment based on an initial direction of entry into a defined sensing region. Turning now to FIG. 8, the proximity sensor device 200 is illustrated with a central sensing region 802 defined and used select the adjustment. In this embodiment, entry into the sensing region 802 from the top (e.g., along the path 804) is used to select one adjustment, and from the bottom (e.g., along the path 806) is used to select another adjustment. For example, entry from the top can be used to select scrolling down, and entry from the bottom used to select scrolling down. Likewise entry from the left side (e.g., along the path 808) can be used to select panning right, and entry from the right side (e.g., along the path 810) can be used to select panning left. In any case the user can select the first adjustment by initially placing the object in the outside the sensing region moving into the sensing region. It should again be noted that in this embodiment once the crossing into the sensing region occurs and selects the adjustment there is no requirement that object motion be limited to within the sensing region. Instead, in most embodiments it will be desirable to facilitate continuation of the selected adjustment responsive to object motion all over the proximity sensor device 200 until the object motion stops, a specific type of user input such as object motion of a particular gesture occurs, or until the object is removed from the sensing region for a relatively longer time period (e.g., after a predetermined time threshold has been met) that indicates that the user does not intend to continue indicating adjustment in the same way. It should also again be noted that this is just one example of how the regions can be defined, and in other embodiments it may be desirable to include additional regions to facilitate additional adjustment selections.

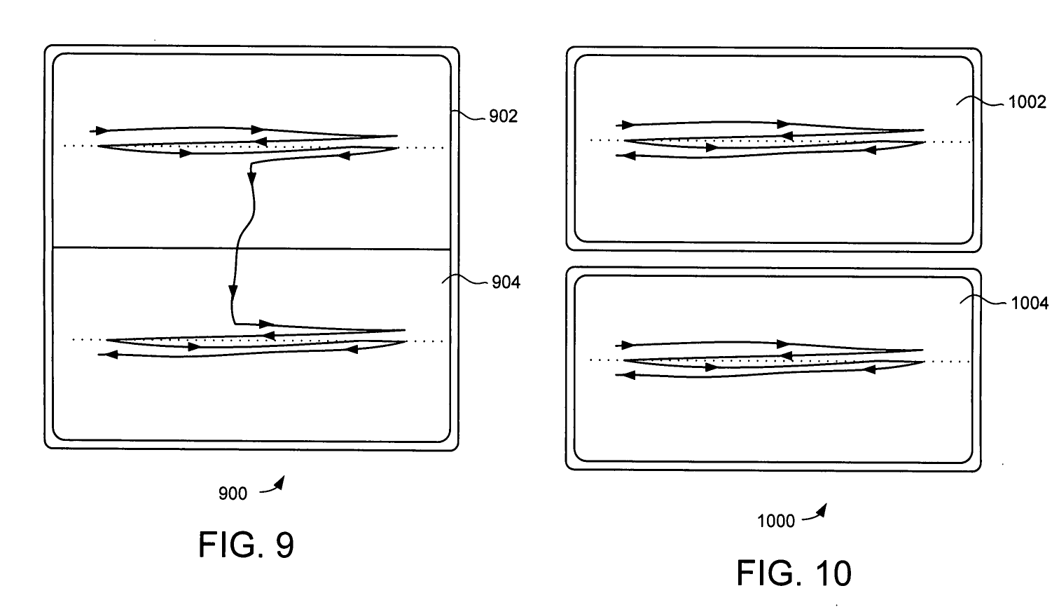

In other embodiments combinations of sensing regions can be implemented to facilitate a variety of different types of adjustments. Turning now to FIG. 9, a proximity sensor device 900 includes two sensing regions 902 and 904. Both sensing regions 902 and 904 can be used to facilitate user input of adjustment responsive to object motion in the two opposite directions along a path. Additionally, the two sensing regions 902 and 904 can be used to facilitate two different types of adjustment. Thus, the user of proximity sensor device 900 can cause adjustment in the first way by moving an object back and forth along a path in the upper region 902, and can cause adjustment in a second way by moving an object back and forth along a path in the lower region 904. The adjustment in the first way and the adjustment in the second way can be opposite each other. For example, the proximity sensor device 900 can be implemented such that moving back and forth along a path in the upper region 902 causes upward scrolling, and moving back and forth along a path in the lower region causes downward scrolling. Additionally, the close proximity of the upper and lower regions allows as user to switch from one way of adjustment to another way of adjustment by simply moving into the other region and moving back and forth along path in the new region. The two sensing regions can be combined with the other adjustment selection techniques described above to facilitate an even larger combination of adjustment types. The proximity sensor device 900 can thus facilitate the entry of extended continuous adjustments of different types and directions, such as long scrolling in both directions, with relatively simple and easy to perform gestures. The sensing regions 902 and 904 can be implemented using in any manner described earlier, including with a sensor having sensing regions capable of providing two-dimensional (2-D) or one-dimensional (1-D) positional information. If sensing regions 902 and 904 are dedicated regions for indicating adjustment, 1-D may be preferable since any lateral motion associated with the object moving from region 902 to 904 (or vice versa) will inherently be ignored, thus saving processing time and resources. In other embodiments, 2-D may be preferable if information about such lateral motion is used by the system, such as to determine whether the user intends to change the adjustment.

It should be noted that the embodiment illustrated in FIG. 9 can be implemented with a variety of different techniques. For example, two sensing regions 902 and 904 can be implemented as part of one larger overall sensing region supported by the proximity sensor device. This larger overall sensing region can comprise just sensing regions 902 and 904 combined, or have areas that extend beyond sensing regions 902 and 904 that improve performance, enable added input or functionality, etc. In other words, sensing regions 902 and 904 can be sub-regions of a larger overall sensing region. In this embodiment shown in FIG. 9, the two sensing regions 902 and 904 may be identified to a user with a visual indicator, physical barrier, and/or textural indicator of the division between the two regions. Such identification can also be used to distinguish sensing regions 902 and 904 from any areas of a larger overall sensing region beyond sensing regions 902 and 904. The two regions can be implemented with the same methodology or technology, or the two regions can be implemented with two or more different sensing methodologies or technologies. Turning now to FIG. 10, a proximity sensor device 1000 includes two sensing regions 1002 and 1004 implemented with separate sensing regions not immediately adjacent to each other. Similar to the embodiment illustrated in FIG. 9, the two sensing regions 1002 and 1004 can be implemented by the sensor of the proximity device with any number of technologies. Of course, these are just two examples of how a proximity sensor device with two sensing regions can be implemented.

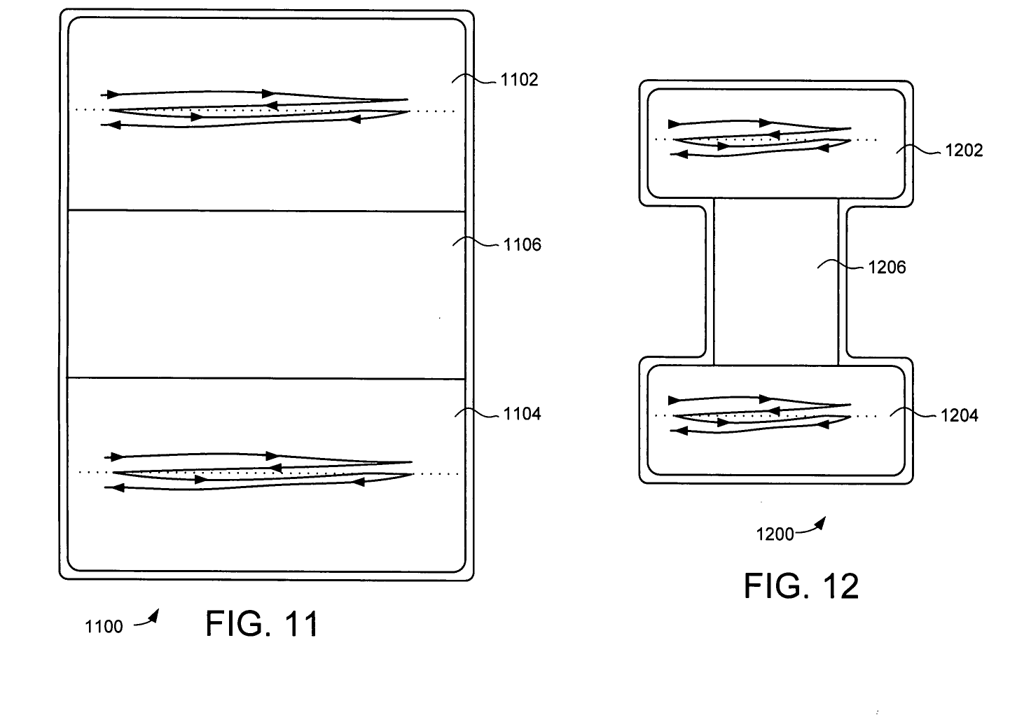

Turning now to FIG. 11, another embodiment of a proximity sensor device 1100 includes two sensing regions 1102 and 1104, and a third sensing region 1106 between them. Again, both sensing regions 1102 and 1104 can be used to facilitate user input of adjustment responsive to object motion in the two opposite directions along a path, and can thus be used to facilitate two different types of adjustment. Additionally, the sensing region 1106 can be used to provide additional functionality, such as traditional cursor control and selection. Thus, the user of proximity sensor device 1100 can cause adjustment in the first way by moving an object back and forth along a path in the upper region 1102, can cause adjustment in a second way by moving an object back and forth along a path in the lower region 1104, and can perform cursor control using object motion in region 1106. Again, the three sensing regions can be combined with the other adjustment selection techniques described above to facilitate an even larger combination of adjustment types.

The sensing region 1106 can also be configured to cause adjustment in a first way or a second way responsive to the direction of the object motion in region 1106. For example, the user of proximity sensor device 1100 can cause upward scrolling by moving an object back and forth along a path in the upper region 1102, can cause downward scrolling by moving an object back and forth along a path in the lower region 1104, and can perform either upward or downward scrolling by moving an object in region 1106 upward or downward, respectively. With such an implementation, the user can, for example, perform one motion that covers two regions to accomplish long coarse scrolling using region 1102 or 1104, and fine targeting using region 1106. Alternatively, the user can perform one motion that covers all three regions and accomplish long coarse scrolling upwards and downwards using regions 1102, 1104, and 1106 for scanning, and slower or bi-directional scrolling for fine targeting using only one region (e.g. region 1106) when the desired target is almost reached.

It should be noted that the embodiment illustrated in FIG. 11 can also be implemented with a variety of different techniques. For example, the three sensing regions can be implemented as part of one larger overall sensing region of the proximity sensor device, or it can be implemented with separate sensing regions using the same or different sensing methodologies. Additionally, a variety of different shapes can be combined. Turning now to FIG. 12, another embodiment of a proximity sensor device 1200 includes two sensing regions 1202 and 1204, and a third sensing region 1206 between them. In this embodiment the three sensing regions combine to define an “I-shape”. With the implementations shown in FIG. 11 and FIG. 12, the user can, for example, perform one motion that covers two regions (regions 1102 and 1104 for the implementation of FIG. 11 or regions 1202 and 1204 for the implementation of FIG. 12) or all three regions (regions 1102, 1104, and 1106 for the implementation of FIG. 11 or regions 1202, 1204, and 1206 for the implementation of FIG. 12). For example, with the implementation shown in FIG. 12, the user can accomplish long coarse scrolling using region 1202 or 1204, and fine targeting using region 1206. Alternatively, the user can perform one motion that covers all three regions and accomplish long coarse scrolling upwards and downwards using regions 1202, 1204, and 1206 for scanning, and slower or bi-directional scrolling for fine targeting using only one region (e.g. region 1206) when the desired target is almost reached. An exemplary single object motion covering all three regions 1202, 1204, and 1206 begins in region 1202 to cause upward scrolling, continues in region 1206 toward region 1204 to cause downward scrolling, and then continues in region 1204 to cause additional downward scrolling. This exemplary single object motion can also continue and return to region 1206 and toward region 1202 if upward scrolling is desired. Again, this is just one example of how three sensing regions can be combined and used.

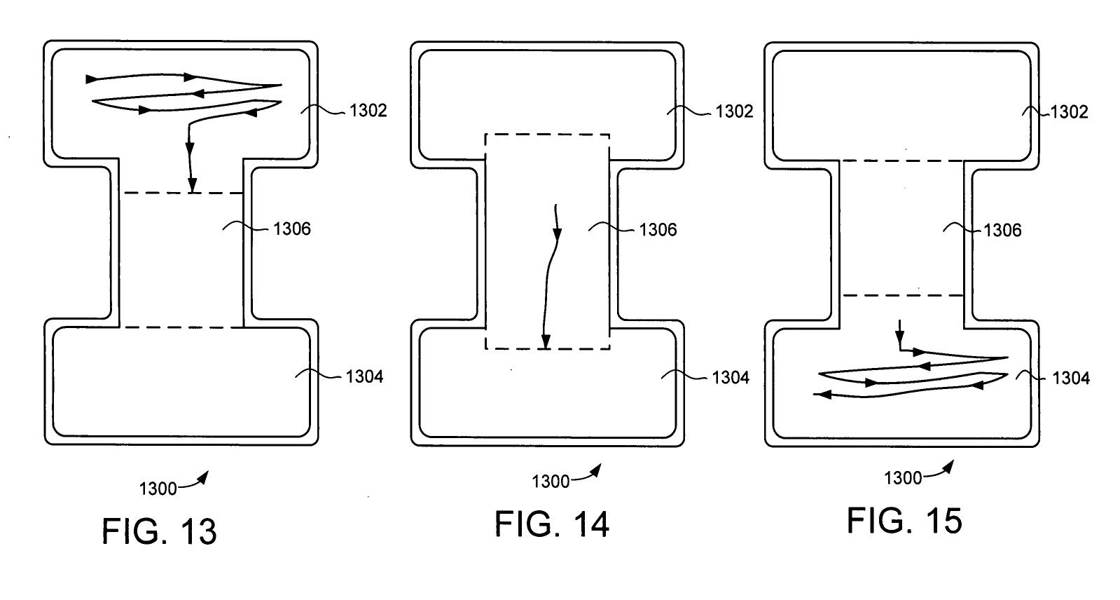

An exemplary single object motion covering all three regions is shown in FIGS. 13-15. This exemplary single object motion begins in region 1302 to cause upward scrolling, continues in region 1306 toward region 1304 to cause downward scrolling, and then continues in region 1304 to cause additional downward scrolling. This exemplary single object motion can also continue and return to region 1306 and toward region 1302 if upward scrolling is desired. In this embodiment, the regions 1302, 1306, and 1304 have been shown in FIGS. 13-15 to change dynamically in response to the object motion. With this dynamic change, when the object motion begins in 1302, the region 1302 is larger to enable easier downward scrolling (FIG. 13); when the object motion continues in region 1306, the region 1306 is larger to enable easier upward and downward scrolling (FIG. 14); and when the object motion continues to region 1304, the region 1304 is made larger to enable easier downward scrolling (FIG. 15). Although a particular set of region size and shape changes are shown in FIGS. 13-15, others are possible. This exemplary single object motion has also been described in conjunction with upward scrolling and downward scrolling, and other adjustments can also be enabled with the proximity sensor device 1300. Again, this is just one example of how three sensing regions can be combined and used.

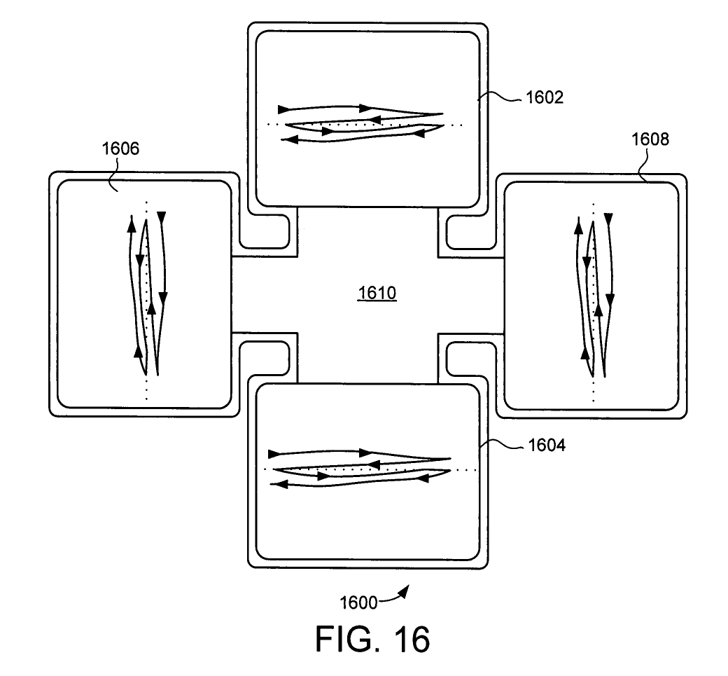

Turning now to FIG. 16, another embodiment of a proximity sensor device 1600 includes four sensing regions 1602, 1604, 1606 and 1608, and a fifth sensing region 1610 between them. Again, the sensing regions 1602, 1604, 1606 and 1608 can be used to facilitate user input of adjustment responsive to object motion in the two opposite directions along a path, and can thus be used to facilitate four different types of adjustment. Additionally, the sensing region 1610 can be used to provide additional functionality, such as traditional cursor control and selection. Alternatively, the sensing region 1610 can provide any subset of the four different types of adjustment. Thus, the user of proximity sensor device 1600 can cause adjustment in the first way by moving an object back and forth along a path in the upper region 1602, can cause adjustment in a second way by moving an object back and forth along a path in the lower region 1604, can cause adjustment in a third way by moving an object back and forth along a path in the left region 1606, can cause adjustment in a fourth way by moving an object back and forth along a path in the right region 1608, and can perform cursor control, selection or adjustment in a subset of the four different types of adjustment using object motion in region 1610. As a specific example, motion in region 1602 can cause scrolling up, motion in region 1604 can cause scrolling down, motion in region 1606 can cause panning left, and motion in region 1608 can cause panning right. Again, the five sensing regions can be combined with the other adjustment selection techniques described above to facilitate an even larger combination of adjustment types.

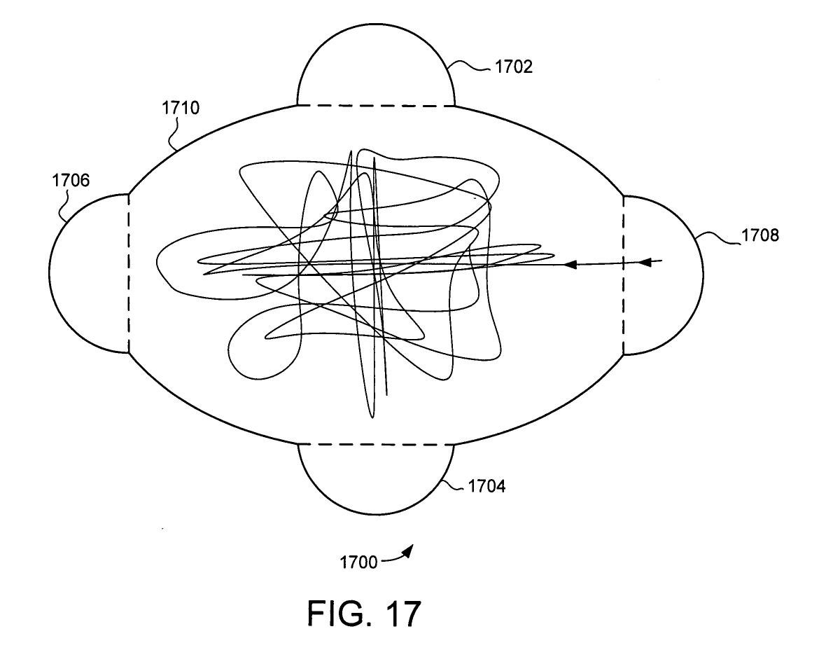

It should be noted that while the sensing regions have been illustrated as rectangular shaped sensing regions, that this is merely exemplary, and that the proximity sensor devices can be implemented with sensing regions in a wide variety of shapes and configurations. Specific examples of other shapes include circular regions or ellipses that may fit input object shapes better, or other shapes that would meet industrial design or space constraints more accurately. Turning now to FIG. 17, another embodiment of a proximity sensor device 1700 includes four outer sensing regions 1702, 1704, 1706 and 1708, and a fifth, central sensing region 1710 between them. In this embodiment the proximity sensor device 1700 can be implemented to select an adjustment based on entry from a selected outer sensing region into the central sensing region 1710. In this embodiment, entry into the sensing region 1710 from the top sensing region 1702 is used to select one adjustment, and from the bottom sensing region 1704 is used to select another adjustment. For example, entry from the top sensing region 1702 can be used to select scrolling down, and entry from the bottom sensing region 1704 used to select scrolling up. Likewise entry from the left sensing region 1706 can be used to select scrolling right (also called panning right), and entry from the right sensing region 1708 can be used to select scrolling left (also called panning left). In any case the user can select the first adjustment by initially placing the object in a selected outer region and moving into the central sensing region 1710. Once the crossing into the sensing region 1710 occurs continued object movement in the sensing region continues the selected adjustment in the same way. It should also again be noted that this is just one example of how the regions can be defined, and in other embodiments it may be desirable to include additional regions to facilitate additional adjustment selections.

Several different techniques can be used to improve the usability of proximity sensor devices in accordance with the embodiments of the invention. For example, in some implementations it will be desirable to not indicate adjustment responsive to signals representing very small or sudden amounts of sensed object motion. Small amounts of sensed object motion can inadvertently result from attempts by the user to pause in the sensing region. In these cases small mounts of motion caused by bodily tremors or shaking in the environment could be interpreted as intended object motion. In addition, a user may reduce or stop paying attention to object motion while examining items on the list, and accidentally drift the object motion. Further, there may also be accidental input from the user accidentally brushing against the sensing region (these are likely to result in sudden amounts of sensed object motion, large or small). Likewise, electronic noise from sources such as power supply(s), EMI, etc. can cause spurious, incorrect signals hinting at object motion that do not exist. In all these cases it can be desirable to not indicate adjustment responsive to these signals indicating small or sudden amounts of sensed object motion to avoid causing inadvertent adjustment when no such adjustment is intended by the user.

One way to address this issue is with the use of filters, such as with the use of threshold values and by gauging if the object motion is beyond one or more threshold levels. Thresholds may be maximum or minimum bounds, such that object motion may be “beyond” a maximum threshold when it is above the threshold level and “beyond” a minimum threshold when it is below the threshold level. For example, by comparing the sensed object motion to a threshold, the system can ignore sensed levels of object motion that are below the threshold and not indicate adjustment. In this case, the threshold can be set to filter out object motion less than what is likely to be indicative of intended input, and the proximity sensor device will not consider amounts of sensed object motion below that threshold to be indicative of object motion. Alternatively, the system can ignore sensed levels of object motion that are above a threshold and not indicate adjustment. In this alternate case, the threshold can be set to filter out object motion greater than what is likely to be indicative of intended input, and the proximity sensor device will not consider amounts of sensed object motion above the threshold to be indicative of object motion. A variety of thresholds can be used, separately or in combination. For example, the system can require that the object motion travel a minimum distance proximate/in the sensing region before responding with adjustment, but accept object motion traveling less than that minimum distance threshold as other input. It should be noted that while object motion below the distance threshold would not generate any indications of adjustment, it could still be used to trigger other input (e.g. selection). Further constraints can be imposed, such as to require that a minimum distance or a maximum distance be traveled within a predetermined amount of time. The threshold may also alternatively be on another characteristic of the object motion, such as requiring that the speed of the object motion be beyond a certain threshold and/or below a particular threshold before generating an indication of an adjustment. Thresholds may also be combined, such that an object motion must travel a minimum distance, within a certain amount of time, and reach at least a minimum speed, before indications of adjustment will be provided. Another combination of thresholds can require that an object motion must travel no more than a maximum distance, within a certain amount of time, and not pass a maximum speed, such that the system will begin or continue indications of adjustment

The exact values of these thresholds vary with a myriad of factors, such as details of the sensing technology, user interface design, and operating conditions. The threshold values may also differ with directions/manners of adjustment, which adjustment is selected, and user preferences. To accommodate this, the threshold values can be made adjustable, such as to change the value in response to determined noisiness of the environment, prior history of typical user input speeds and distances, which adjustment is currently selected, which direction/manner of adjustment is current active, user definition, or the like.

One issue where a threshold may be particularly applicable is in determining when object motion has crossed from one region to another. For example, it may be desirable to require travel into the region a certain distance before adjustment associated with that region would be indicated. This may be quite useful for systems where a first sensing region configured to indicate an adjustment abuts a second sensing region configured to indicate an adjustment in an opposing way, to indicate a different adjustment, or for something else completely (e.g. cursor control). To start adjustment associated with the first region with object motion that begins in the second region and traverses through the abutting section into the first region, the object motion must first travel into the first region a certain distance. Otherwise, no indications or indications reflective of the second region will be generated. This can implement a “hysteresis” in the operation of the sensing regions, based on the assumption that the user wants to continue a current operation when using a continuous stroke without leaving the proximity of the sensing region.

The present invention thus provides a proximity sensor device and method that facilitates improved system usability. Specifically, the proximity sensor device and method provide the ability for a user to easily cause adjustments in an electronic system using a proximity sensor device as a user interface. For example, it can be used to facilitate user interface navigation, such as scrolling. As another example, it can be used to facilitate value adjustments, such as changing a device parameter. To facilitate adjustment, the embodiments of the present invention provide a proximity sensor device that is adapted to indicate adjustment in a first way responsive to object motion in both of two opposite directions along a path proximate the touch sensor device. This facilitates use of the proximity sensor device by a user to indicate adjustments to an electronic device, and is particularly useful for indicating continuing adjustments.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

What is claimed is:

1. A proximity sensor device, the proximity sensor device comprising:
a sensor, the sensor adapted to detect object motion proximate a first sensing region; and
a processor, the processor coupled to the sensor and adapted to indicate adjustment in a first way responsive to object motion in a first of two opposite directions along a path proximate the first sensing region, and further adapted to indicate adjustment in the first way responsive to object motion in a second of the two opposite directions along the path proximate the first sensing region.

2. The proximity sensor device of claim 1 wherein the adjustment comprises user interface navigation.

3. The proximity sensor device of claim 2 wherein the interface navigation comprises scrolling.

4. The proximity sensor device of claim 3 wherein the processor is further configured to cause selection responsive to object lifting.

5. The proximity sensor device of claim 1 wherein the adjustment comprises a value adjustment.

6. The proximity sensor device of claim 1 wherein the adjustment is changeable.

7. The proximity sensor device of claim 6 wherein the adjustment is changeable responsive to a location of an initial object motion proximate the first sensing region.

8. The proximity sensor device of claim 6 wherein the adjustment is changeable responsive to a direction of entry of object motion into the first sensing region.

9. The proximity sensor device of claim 6 wherein the adjustment is changeable to modify at least one of a rate of adjustment and a direction of adjustment.

10. The proximity sensor device of claim 6 wherein the adjustment is changeable to modify a type of adjustment.

11. The proximity sensor device of claim 1 wherein the proximity sensor device is implemented to input to a host device.

12. The proximity sensor device of claim 11 wherein the host device comprises a media player.

13. The proximity sensor device of claim 11 wherein the host device comprises a communication device.

14. The proximity sensor device of claim 1 wherein the sensor is further adapted to detect object motion proximate a second sensing region; and wherein the processor is further adapted to indicate adjustment in a second way responsive to object motion in a first of two opposite directions along a path proximate the second sensing region, and further adapted to indicate adjustment in the second way responsive to object motion in a second of the two opposite directions along the path proximate the second sensing region.

15. The proximity sensor device of claim 14 wherein the adjustment in the first way comprises scrolling in a first manner and wherein the adjustment in the second way comprises scrolling in a second manner opposite the first manner.

16. The proximity sensor device of claim 14 wherein the adjustment in the first way comprises a value adjustment in a first manner and wherein the adjustment in the second way comprises a value adjustment in a second manner opposite the first manner.

17. The proximity sensor device of claim 14 wherein the sensor is further adapted to detect object motion proximate a third sensing region, and wherein the processor is further adapted to indicate adjustment responsive to the object motion proximate the third sensing region.

18. The proximity sensor device of claim 17 wherein the third sensing region is positioned between the first sensing region and the second sensing region.

19. The proximity sensor device of claim 17 wherein the first sensing region, the second sensing region, and the third sensing region together form an I-shape.

20. The proximity sensor device of claim 1 wherein the sensor is configured to sense in one single dimension.

21. The proximity sensor device of claim 1 wherein the sensor is configured to sense in at least two dimensions.

22. The proximity sensor device of claim 1 wherein the sensor comprises a capacitive sensor.

23. The proximity sensor device of claim 1 wherein the sensor comprises a resistive sensor.

24. The proximity sensor device of claim 1 wherein the sensor comprises an inductive sensor.

25. The proximity sensor device of claim 1 wherein the processor is configured to not indicate adjustment in the first way responsive to object motion in a first of two opposite directions along a path proximate the first sensing region when said object motion is beyond a threshold level.

26. The proximity sensor device of claim 1 wherein a dimension of the first sensing region is changeable.

27. A proximity sensor device, the proximity sensor device comprising:
a sensor, the sensor adapted to detect object motion proximate a first sensing region and to detect object motion proximate a second sensing region; and
a processor, the processor coupled to the sensor and adapted to indicate scrolling in a first way responsive to object motion in a first of two opposite directions along a path proximate the first sensing region, and further adapted to indicate scrolling in the first way responsive to object motion in a second of the two opposite directions along the path proximate the first sensing region, the processor further adapted to indicate scrolling in a second way responsive to object motion in a first of two opposite directions along a path proximate the second sensing region, and further adapted to indicate scrolling in the second way responsive to object motion in a second of the two opposite directions along the path proximate the second sensing region.

28. A proximity sensor device, the proximity sensor device comprising:
a sensor, the sensor adapted to capacitively detect object motion proximate a first sensing region, a second sensing region, and a third sensing region, the third sensing region located between the first sensing region and the second sensing region; and
a processor, the processor coupled to the sensor and adapted to indicate adjustment in a first way responsive to object motion in a first of two opposite directions along a path proximate the first sensing region, and further adapted to indicate adjustment in the first way responsive to object motion in a second of the two opposite directions along the path proximate the first sensing region, the processor further adapted to indicate adjustment in a second way responsive to object motion in a first of two opposite directions along a path proximate the second sensing region, and further adapted to indicate adjustment in the second way responsive to object motion in a second of the two opposite directions along the path proximate the second sensing region, and wherein the processor is further adapted to indicate adjustment responsive to the object motion proximate the third sensing region.

29. A method of indicating adjustment in a device, the method comprising:
detecting object motion proximate a first sensing region in a first of two opposite directions along a path proximate the first sensing region; and
indicating adjustment in a first way responsive to the object motion in the first of the two opposite directions along the path proximate the first sensing region;
detecting object motion proximate the first sensing region in a second of two opposite directions along the path proximate the first sensing region; and
indicating adjustment in the first way responsive to the object motion in the second of the two opposite directions along the path proximate the first sensing region.

30. The method of claim 29 wherein the adjustment comprises user interface navigation.

31. The method of claim 30 wherein the interface navigation comprises scrolling.

32. The method of claim 29 wherein the adjustment comprises a value adjustment.

33. The method of claim 29 further comprising the step of changing the indicated adjustment.

34. The method of claim 33 wherein the step of changing the indicated adjustment comprises changing the first way of the adjustment responsive to one of a location of an initial object motion proximate the first sensing region and a direction of entry of object motion proximate the first sensing region.

35. The method of claim 33 wherein the step of changing the indicated adjustment comprises changing one of a rate of adjustment and a direction of adjustment.

36. The method of claim 33 wherein the step of changing the indicated adjustment comprises changing a type of adjustment.

37. The method of claim 29 wherein the step of indicating adjustment in a first way responsive to the object motion in the first of the two opposite directions along the path proximate the first sensing region comprises indicating adjustment to a host device and wherein the step of indicating adjustment in the first way responsive to the object motion in the second of the two opposite directions along the path proximate the first sensing region comprises indicating adjustment to the host device.

38. The method of claim 29 further comprising:
detecting object motion proximate a second sensing region in a first of two opposite directions along a path proximate the second sensing region; and
indicating adjustment in a second way different from the first way responsive to the object motion in the first of the two opposite directions along the path proximate the second sensing region;
detecting object motion proximate the second sensing region in a second of two opposite directions along the path proximate the second sensing region; and
indicating adjustment in the second way responsive to the object motion in the second of the two opposite directions along the path proximate the second sensing region.

39. The method of claim 38 wherein the adjustment in the first way comprises scrolling in a first manner and wherein the adjustment in the second way comprises scrolling in a second manner opposite the first manner.

40. The method of claim 38 wherein the adjustment in the first way comprises a value adjustment in a first manner and wherein the adjustment in the second way comprises a value adjustment in a second manner opposite the first manner.

41. The method of claim 38 further comprising:
detecting object motion proximate a third sensing region; and
indicating adjustment responsive to the object motion proximate the third sensing region.

42. The method of claim 29 wherein the step of indicating adjustment in a first way responsive to the object motion in the first of the two opposite directions along the path proximate the first sensing region comprises indicating adjustment only when the object motion exceeds a first threshold, and wherein the step of indicating adjustment in the first way responsive to the object motion in the second of the two opposite directions along the path proximate the first sensing region comprises indicating adjustment only when the object motion exceeds a second threshold.

43. A program product comprising:
a) a proximity sensor program, the proximity sensor program adapted to indicate adjustment in a first way responsive to object motion in a first of two opposite directions along a path proximate a first sensing region on a proximity sensor device, the proximity sensor program further adapted to indicate adjustment in the first way responsive to object motion in a second of the two opposite directions along the path proximate the first sensing region; and
b) computer-readable media bearing said proximity sensor program.
